(19) United States
(12) Patent Application Publication
(10) Pub. No.: US 2026/0222313 A1
(43) Pub. Date: Jul. 30, 2026

(54) DYNAMICALLY RECOMMENDING NETWORK TUNNELS

(71) Applicant: Palo Alto Networks, Inc., Santa Clara, CA (US)

(72) Inventors: Naga Raghu Ramprasad Nandigama, Bengaluru (IN); Harsha Kumar Subramanya Gupta, Mysore (IN); Arunkumar Desigan, Bangalore (IN); Anil Kumar Reddy Sirigiri, Bangalore (IN)

(21) Appl. No.: 19/039,173

(22) Filed: Jan. 28, 2025

(51) Int. Cl. H04L 41/16; H04L 12/46; H04L 41/0806; H04L 41/122

(52) U.S. Cl. CPC H04L 41/16; H04L 12/4633; H04L 41/0806; H04L 41/122

(57) ABSTRACT

Identifications of nodes of a software defined networking network are received. Identifications of existing network tunnels connecting the nodes of the software defined networking network are received. Metrics for the nodes and the existing network tunnels are collected. A graph representation of the nodes and the existing network tunnels with the collected metrics is generated. Based on the graph representation, one or more machine learning models are used to identify a suggested new network tunnel between two nodes included in the nodes of the software defined networking network.

### BACKGROUND OF THE INVENTION

A software defined wide area network (SDWAN) can be utilized for network management and security to improve application performance and user application experience. Paths between nodes of an SDWAN can be created or removed to reduce network traffic. Although SDWAN solutions may automatically create paths between nodes by implementing full or semi-mesh network topology models, they often require manual intervention to optimize paths when catering to specific traffic requirements. In addition, full-mesh and semi-mesh network models are resource intensive and difficult to implement efficiently on a large-scale network. Therefore, there exists a need for more efficient methodologies of determining paths between nodes in SDWAN or network environments.

### BRIEF DESCRIPTION OF THE DRAWINGS

Various embodiments of the invention are disclosed in the following detailed description and the accompanying drawings.

FIG. 1 is a block diagram illustrating an example of a network environment for dynamical recommendations of tunnels in software defined networking networks.

FIG. 2A is a diagram illustrating an example of a software defined networking network where optimization solutions can be applied.

FIG. 2B is a diagram illustrating an example of a manual solution for managing bottlenecks in a software defined networking network.

FIG. 2C is a diagram illustrating an example of a multilayered software defined networking network where optimization solutions can be applied.

FIG. 2D is a diagram illustrating an example of a manual solution for managing bottlenecks in a multilayered software defined networking network.

FIG. 3A is a diagram illustrating an embodiment of software defined networking with a dynamic recommendation of a tunnel.

FIG. 3B is a diagram illustrating an embodiment of multilayered software defined networking with a dynamic recommendation of a tunnel.

FIG. 4 is a flow chart illustrating an embodiment of a process for performing dynamic recommendations of tunnels in software defined networking.

FIG. 5 is a flow chat illustrating an embodiment of a process for determining suggested tunnels based on a graph representation of a software defined networking network.

FIG. 6 is a functional diagram illustrating a programmed computer system for a method to dynamically recommend tunnels in software defined networking environments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Dynamically recommending tunnels in software defined networking networks (e.g., SDWAN) is disclosed. For example, one or more machine learning models are utilized to analyze structural features and network metrics of the software defined networking network to dynamically recommend network tunnels. In some embodiments, information about the nodes and the existing tunnels connecting the nodes in the software defined networking network are received. A representation of the software defined networking network is created using the data received and analyzed by one or more machine learning models to suggest a new network tunnel to create between two or more existing nodes in the software defined networking network. In some embodiments, an existing tunnel between two or more existing nodes in the software defined networking network may be identified for deactivation. Analysis of the software defined networking network by machine learning models automates a previously laborious process and enables the network to be evaluated and optimized on dimensions and features indeterminable by humans. In addition, machine learning analysis can be performed on the software defined networking network as the network changes, allowing continued optimizations of the software defined networking network as it grows larger, improving overall application performance and user application experience.

In some embodiments, identifications of nodes of a software defined networking network are received. The software defined networking network may be a software defined wide area network. Identifications of a node include but are not limited to the number of edges, paths, or tunnels connected to it, the set of nodes directly connected to it, its type, and the types of nodes it is connected to. Identification of existing network tunnels connecting the nodes of the software defined networking network is received. For example, tunnel attributes indicating whether the tunnel can be edited, if the tunnel was created automatically or manually, which nodes it is connecting, and the types of nodes it is connecting are received. Metrics for the nodes and the existing network tunnels are collected. Examples of collected node metrics include central processing unit utilization, memory utilization, data throughput, and maximum concurrent network tunnel flow. Examples of collected tunnel metrics include network latency, jitter, packet loss, network bandwidth, and available bandwidth. A graph representation of the nodes and existing network tunnels with the collected metrics is generated. For example, the nodes, existing network tunnels, and collected metrics are represented as an adjacency list, edge list, or adjacency matrix. Based on the graph representation, one or more machine learning models are used to identify a suggested new network tunnel between at least two nodes included in the nodes of the software defined networking network. In some embodiments, one or more machine learning models may be used to identify a suggested network tunnel of the existing network tunnels to deactivate.

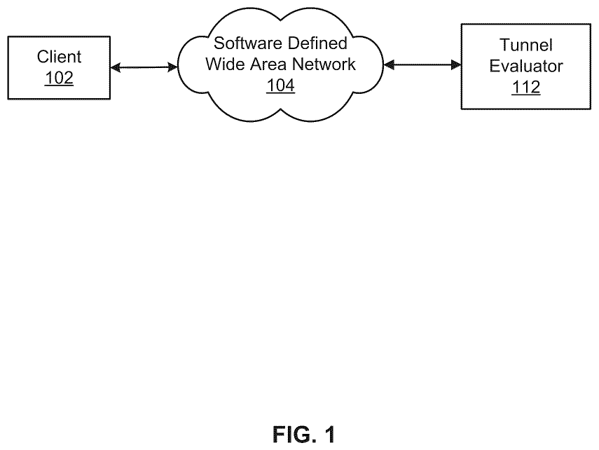

FIG. 1 is a block diagram illustrating an example of a network environment for dynamical recommendations of tunnels in software defined networking networks. In the example shown, client 102 and tunnel evaluator 112 are connected via software defined wide area network 104. Software defined wide area network 104 includes nodes and network tunnels connecting the nodes. In some embodiments, the nodes include routers, branches, and a data center. For example, all the branch routers have a tunnel to the data center, which manages network resources and connectivity. In various embodiments, the nodes include a branch gateway or a secure access service edge end-point.

In some embodiments, client 102 is an example client connected to a software defined networking network such as software defined wide area network 104. For example, when client 102 navigates the internet, data sent between client 102 and the internet is analyzed and processed by software defined wide area network 104. The network determines the most optimal path for the data and transmits it, monitoring the data as it travels between the client and the internet. In some embodiments, software defined wide area network 104 applies security protocols to the data. Throughout the process, software defined wide area network 104 measures performance metrics and may dynamically adjust the routing to optimize the experience of client 102.

In some embodiments, tunnel evaluator 112 is a module for optimizing software defined wide area network 104. For example, tunnel evaluator 112 receives identification of the nodes and network tunnels of software defined wide area network 104 and their corresponding performance metrics and identifies a suggested new network tunnel between two nodes included in software defined wide area network 104. In some embodiments, tunnel evaluator 112 also identifies a suggested network tunnel of the existing network tunnels in software defined wide area network 104 to deactivate. In various embodiments, tunnel evaluator 112 includes one or more machine learning models that are used to identify a suggested new network tunnel or suggested existing network tunnel to deactivate. For example, tunnel evaluator 112 may include a graph neural network model and/or a graph attention network model. In some embodiments, the one or more machine learning models are trained using deployed previous network topology data.

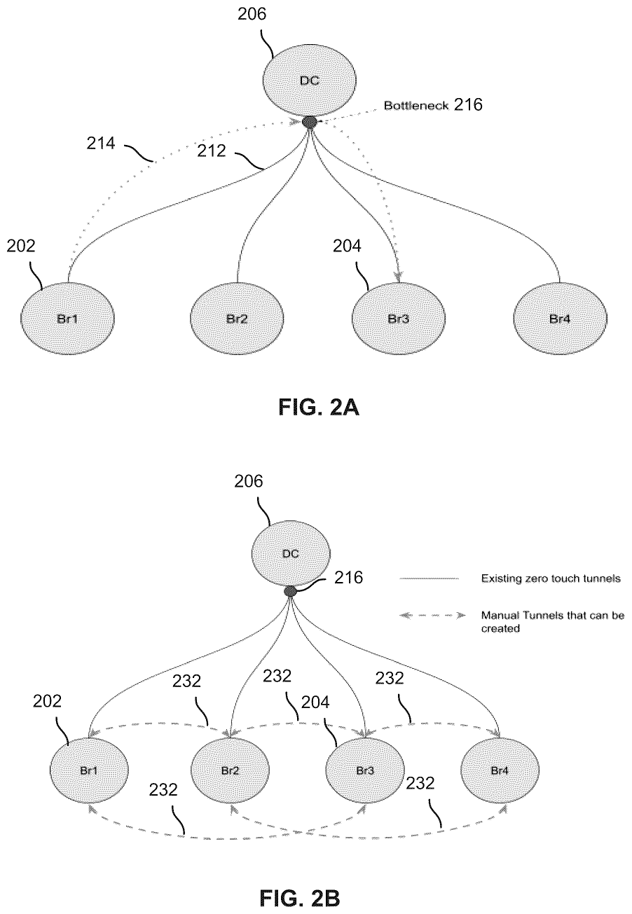

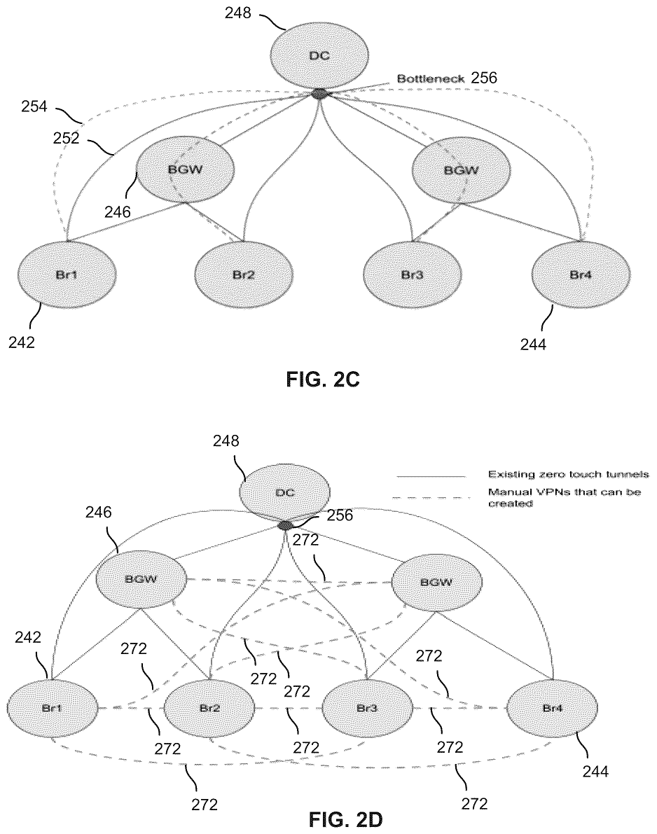

FIG. 2A is a diagram illustrating an example of a software defined networking network where optimization solutions can be applied. For example, the components of FIG. 2A include a basic implementation of a software defined networking solution. In various embodiments, node 202, node 204, data center 206, existing tunnel 212, data flow 214, and bottleneck 216 form example components of a software defined network. In some embodiments, the software defined network is a software defined wide area network.

In some embodiments, nodes 202 and 204 are branch routers of the software defined networking network. Node 202 is connected to data center 206 via existing tunnel 212. Existing tunnel 212 is a path in which data can flow from node to data center or from node to node. In some embodiments, existing tunnel 212 is a tunnel that is established as an initial default configuration. For example, when the software defined networking network is created, a tunnel is established between each branch node and the data center. Bottleneck 216 indicates a location in the software defined network where there is impeded data traffic flow due to a large volume of traffic flowing through that area. For example, the existing tunnels between the data center and the nodes in the software defined graph create a bottleneck due to all tunnels from different nodes connecting to the same data center. Data flow 214 demonstrates that data flowing from node 202 to node 204 would be hindered due to bottleneck 216. Bottleneck 216 slows the processes of the software defined network, impacting its overall performance and the user experience.

FIG. 2B is a diagram illustrating an example of a manual solution for managing bottlenecks in a software defined networking network. For example, the components of FIG. 2B illustrate how manual tunnels can mitigate the data flow at the bottleneck of the software defined networking network shown in FIG. 2A. In order to reduce network traffic that must pass through bottleneck 216 in order for nodes to communicate with one another, mesh of tunnels 232 can be manually created. However, manually creating such a large number of tunnels may be resource intensive and inefficient. While some of manually created tunnels 232 may get utilized, others may be underutilized to justify spending resources to create and maintain a tunnel.

FIG. 2C is a diagram illustrating an example of a multilayered software defined networking network where optimization solutions can be applied. In the example shown, node 242, node 244, boarder gateway node 246, data center 248, existing tunnel 252, data flow 254, and bottleneck 256 form example components of a software defined networking network (e.g., software defined wide area network).

In some embodiments, node 242 and node 244 are branch routers of a software defined networking network. Node 242 is connected to data center 248 via existing pre-established tunnel 252. Node 242 may send data to node 244 through existing tunnel 252, data center 248, and an existing tunnel between node 244 and data center 248. This flow of data is represented by data flow 254. In the diagram, all tunnels run through data center 248, creating a large amount of data traffic in one location, referred to as bottleneck 256. Bottleneck 256 slows down processes such as data flow 254, negatively impacting network performance and user experience.

In some embodiments, node 242 is also connected to data center 248 via node 246. Data travelling from node 242 to node 244 may travel through node 246 and be processed by node 246. In some embodiments, node 246 is a branch gateway or secure access service edge end point. Data travelling from node 242 to another node such as node 244 also goes through bottleneck 256. Bottleneck 256 impacts data travel between all types of nodes regardless of the node's layer in the software defined network.

FIG. 2D is a diagram illustrating an example of a manual solution for managing bottlenecks in a multilayered software defined networking network. For example, the components of FIG. 2D illustrate how manual tunnels can mitigate the data flow at the bottleneck of the software defined networking network shown in FIG. 2C. In order to reduce network traffic that must pass through bottleneck 256 in order for nodes to communicate with one another, mesh of tunnels 272 can be manually created. However, manually creating such a large number of tunnels may be resource intensive and inefficient. While some of manually created tunnels 272 may get utilized, others may be underutilized to justify spending resources to create and maintain a tunnel. Although implementation of all possible tunnels may create a full-mesh network and reduce performance issues caused by bottleneck 256, this approach is limited by cost of maintenance and network scalability.

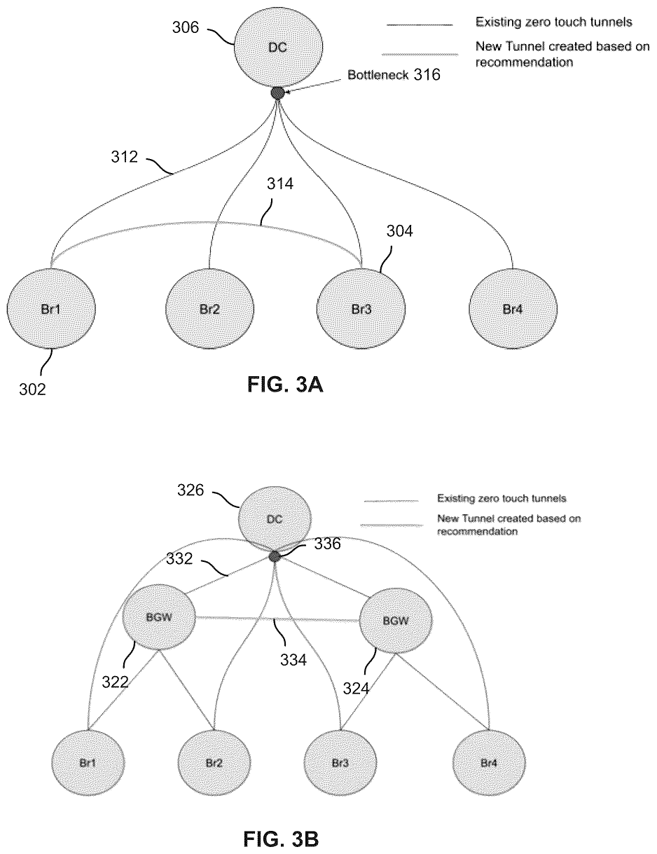

FIG. 3A is a diagram illustrating an embodiment of software defined networking with a dynamic recommendation of a tunnel. For example, a new optimal network tunnel between two existing nodes in the software defined networking network is automatically recommended and established. In some embodiments, node 302, node 304, data center 306, existing tunnel 312, new tunnel 314, and bottleneck 316 form example components of a software defined networking network with a dynamic recommendation of tunnels. In some embodiments, node 302 is node 202, node 304 is node 204, data center 306 is data center 206, existing tunnel 312 is existing tunnel 212, and bottleneck 316 is bottleneck 216 of FIG. 2A.

In some embodiments, new automatic tunnel 314 is created based on an analysis of the existing nodes and tunnels of the software defined networking network. For example, possible tunnels between existing nodes in the software defined networking network, such as possible tunnels 232 of FIG. 2B, are evaluated, and one or more of the possible tunnels determined to optimize the software defined networking network are recommended for creation. In some embodiments, the tunnels are analyzed by one or more machine learning models and the tunnels are recommended based on network performance metrics. The creation of new tunnel 314 provides a communication path between node 302 and node 304, easing the bottleneck between the data center and all of the nodes. In addition, new tunnel 314 may be created automatically without intervention from a network administrator, reducing costs while maintaining network performance as the network changes.

FIG. 3B is a diagram illustrating an embodiment of multilayered software defined networking with a dynamic recommendation of a tunnel. For example, a new optimal network tunnel between two existing nodes in the software defined networking network is automatically recommended and established. In some embodiments, node 322, node 324, data center 326, existing tunnel 332, new tunnel 334, and bottleneck 336 form example components of a multilayered software defined networking network with dynamic recommendation of network tunnels. In some embodiments, node 322 is node 246, data center 326 is data center 248, and bottleneck 336 is bottleneck 256 of FIG. 2C.

In some embodiments, new automatic tunnel 334 is created based on an analysis of the existing nodes and tunnels of the software defined networking network. For example, possible tunnels between existing nodes in the software defined networking network, such as tunnels 272 of FIG. 2D, are evaluated, and one or more of the possible tunnels determined to optimize the software defined networking network are recommended for creation. In some embodiments, the tunnels are analyzed by one or more machine learning models and the tunnels are recommended based on network performance metrics. The creation of new tunnel 334 provides a communication path between node 322 and node 324, reducing the utilization of bottleneck 336. In addition, new tunnel 334 may be created automatically without intervention from a network administrator, reducing costs while maintaining network performance as the network changes, allowing the software defined networking network to be optimized almost instantaneously and periodically.

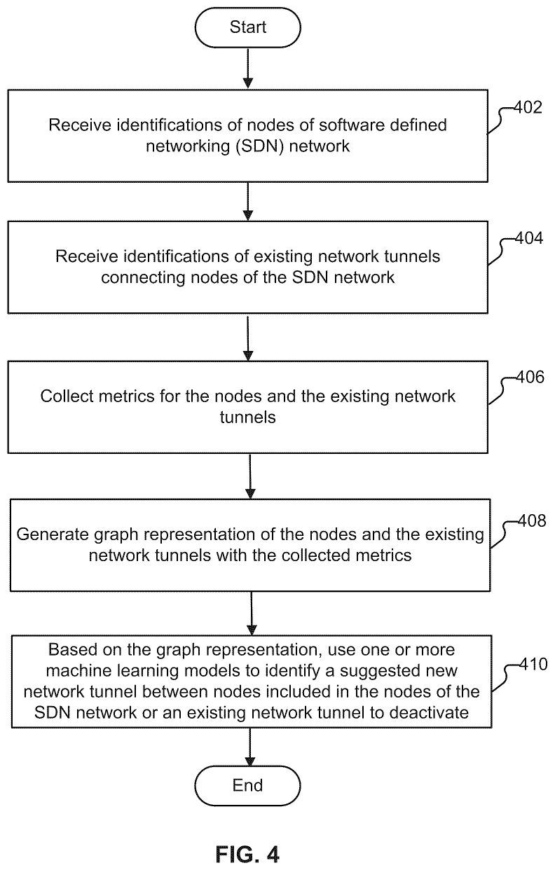

FIG. 4 is a flow chart illustrating an embodiment of a process for performing dynamic recommendations of tunnels in software defined networking. For example, using the process of FIG. 4, a software defined networking network is analyzed by one or more machine learning models to identify suggested new network tunnels between nodes in the software defined networking network. In some embodiments, the software defined networking network includes a software defined wide area network. In some embodiments, the process of FIG. 4 is executed by tunnel evaluator 112 of FIG. 1. In various embodiments the process of FIG. 4 is performed periodically to maintain optimal performance of the software defined networking network as additional nodes are inserted or existing nodes are removed.

At 402, identifications of nodes of a software defined networking network are received. In some embodiments, the nodes include branch routers and a data center. For example, the software defined networking network consists of routers connected to each other via the data center. In some embodiments, each software defined networking network includes only one data center. In various embodiments the nodes include a branch gateway or a secure access service edge end point. For example, the branch gateways contain the same functionality as a branch router but provide additional services and intelligence not offered by branch routers or the data center. Identifications of a node include but are not limited to the number of edges, paths, or tunnels connected to it, the set of nodes directly connected to it, its type, and the types of nodes it is connected to. In some embodiments, the nodes are all of the same type. For example, routers, branches, data centers, and branch gateways are the same type of node, and the software defined networking network contains branch routers, a data center, secure access service edge endpoint, and a branch gateway.

At 404, identifications of existing network tunnels connecting nodes of the software defined networking network are received. In some embodiments, the network tunnels included in the existing network tunnels were established automatically as an initial default configuration. Identifications of existing network tunnels include but are not limited to values indicating whether the tunnel can be edited, whether the tunnel was created automatically or manually, which nodes the tunnel is connecting, and/or the type(s) of nodes the tunnel is connecting.

At 406, metrics for the nodes and the existing network tunnels are collected. In some embodiments, the metrics for the nodes include one or more of the following: a central processing unit utilization value, a memory utilization value, a data throughput value, or a maximum concurrent network tunnel flow value. These metrics may be used to measure the efficiency and overall performance of the node. In some embodiments, the metrics for the existing network tunnels include one or more of the following: a network latency value, a jitter value, a packet loss value, a network bandwidth utilization value, or an available bandwidth metric. These metrics may measure the speed, efficiency, or other capabilities of the network. In some embodiments, the metrics collected may be modified by a network administrator. For example, the metrics may be adjusted based on the user or client's network performance preferences. In some embodiments, the metrics are based on overall network performance and user application experience.

At 408, a graph representation of the nodes and the existing network tunnels with the collected metrics is generated. For example, the software defined networking network is represented as a graph that stores the structure, attributes, and collected metrics of the software defined networking network. In some embodiments, the graph representation of the software defined networking network and its components may be in the form of a matrix, list, objects, and/or dictionary. For example, the graph representation is an adjacency list, edge list, and/or adjacency matrix. The graph representation may be generated programmatically, by a software, an application, or a machine learning model. Example of nodes in the graph representation include branch router, branch gateway, data center, Prisma Access, and Zscaler endpoints, and the nodes are considered to be of the same type as a homogenous graph. Each node of the graph representation may have properties such as resources and their current metric (e.g., CPU utilization, memory utilization, bandwidth/data throughput, maximum concurrent flows, etc.). Each edge of the graph representation may have properties such as quality metrics (e.g., latency) and bandwidth/data throughput.

At 410, based on the graph representation, one or more machine learning models are used to identify a suggested new network tunnel between nodes included in the nodes of the software defined networking network or an existing network tunnel to deactivate. In some embodiments, the one or more machine learning models include a graph neural network model or a graph attention network model. For example, the graph representation is passed into the graph neural network model and or the graph attention network model and one or more suggested new network tunnels are identified. The recommended tunnel(s) are aimed at better application performance and user application experience, which can be quantified by overall reduction of application latency, jitter, and drops due to network congestion and quality of service at the network level. In some embodiments, the one or more machine learning models are trained using deployed previous network topology data. For example, the one or more machine learning models are trained on graph representations of manually optimized software defined networking networks to optimize collected network metrics and performance.

In some embodiments, using one or more machine learning models to identify a suggested new network tunnel or an existing network tunnel to deactivate includes determining embeddings for the graph representation and analyzing the embedding. For example, an embedding is generated for each node and its corresponding metrics and each tunnel and its corresponding metrics and the embeddings are evaluated. In some embodiments, the graph representation is provided to a graph neural network model. The data of the graph representation passes through multiple neural network layers of graph attention networks and graph convolution layers or other graph neural network layers. In some embodiments, the graph neural network layers utilize message passing and message aggregation sub-tasks at each layer and generate lower dimension embedding for each node of the graph representation. These embeddings will have encoded low-level information related to properties of the nodes (e.g., graph properties like degree of node, clustering coefficient of node, betweenness centrality of nodes, etc.). These graph properties infer the role of networking devices in the overall network topology. For example, a higher degree of node infers higher VPN termination to a device like Data Center or Hub Device, and higher betweenness centrality of node infers popular transit points in the network like branch gateway.

In some embodiments, evaluating the embeddings may include determining the embedding distance between each node, comparing the embeddings of suggested tunnels with the embeddings of existing tunnels, or comparing the embeddings to previous network topology data. The evaluation of suggested network tunnels may be performed by one or more machine learning models, algorithms, rules, or a combination of methods. In some embodiments, the suggestion of new network tunnels and deactivation of existing network tunnels is based on the probability of a tunnel existing between the two or more specified nodes determined by a machine learning model trained to optimize network performance.

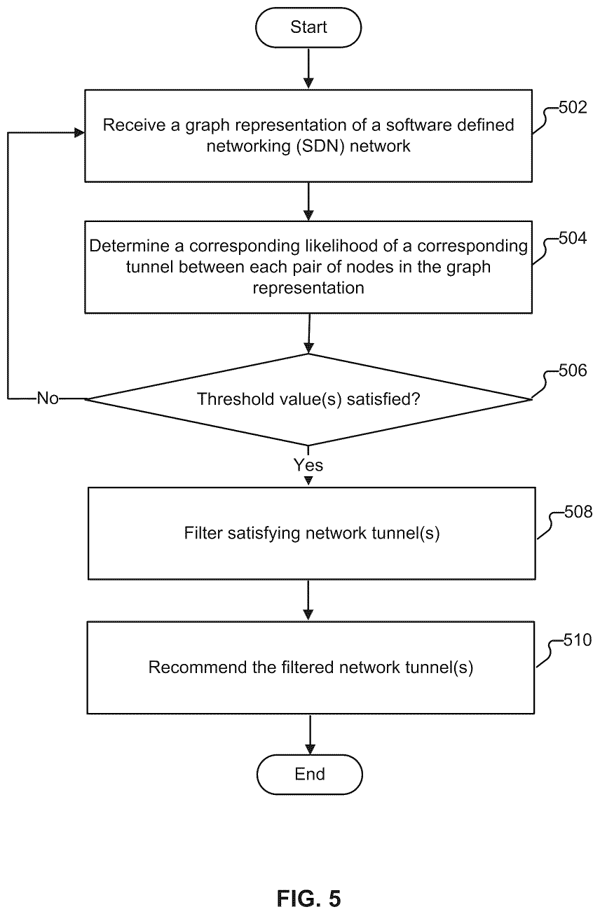

FIG. 5 is a flow chat illustrating an embodiment of a process for determining suggested tunnels based on a graph representation of a software defined networking network. For example, using the process of FIG. 5, suggested new network tunnels are identified and recommended for addition to the software defined networking network. As another example, using the process of FIG. 5, one or more existing network tunnels are identified and suggested for deactivation in the software defined networking network. In some embodiments, the software defined networking network is software defined wide area network 104 of FIG. 1. In some embodiments, the process of FIG. 5 is executed by tunnel evaluator 112 of FIG. 1. In various embodiments, the process of FIG. 5 is performed in step 410 of FIG. 4.

At 502, a graph representation of a software defined networking network is received. For example, the nodes, existing network tunnels, and node and network tunnel attributes are stored in a graph representation and received. In some embodiments, the graph representation contains embeddings of the nodes and existing network tunnels of the software defined networking network. As an example, an embedding for a node included in the nodes is based at least in part on one or more of the following: a degree of the node, a clustering coefficient of the node, or a betweenness centrality of the node, and wherein the embedding is one of the embeddings for the graph representation. In some embodiments, the embedding includes the metrics for the node or existing network tunnel.

At 504, a corresponding likelihood of recommending a corresponding network tunnel between each pair of nodes in the graph representation is determined. For example, the graph representation of the software defined networking network is passed to one or more machine learning models and the corresponding likelihood of recommending a tunnel between each pair of nodes in the graph is determined. In some embodiments, the machine learning model is trained using data from previously deployed networks with previously optimized network tunnels. In some embodiments, the likelihood of recommending a network tunnel is based on whether establishment of the network tunnel would result in a reduction of network latency, jittery, and/or packet drops.

In some embodiments, determining the corresponding likelihood of recommending a network tunnel between two nodes includes determining the distance between vector embeddings of the nodes. For example, the probability of a network tunnel recommended between two nodes is a function of the distance of the embeddings of the nodes. As another example, the probability of a network tunnel recommended between two nodes has an inverse relationship with the determined embedding distance. A short embedding distance between the embeddings of two nodes may represent optimized network metrics for nodes and or network tunnels.

At 506, it is determined whether any of the corresponding recommendation likelihoods satisfy one or more threshold values. For example, the recommendation likelihood value from step 504 is compared to a specified threshold value to determine whether between two nodes a tunnel should be recommended for establishment or whether an already existing tunnel should be removed. In some embodiments, the threshold value is determined during training of the one or more machine learning models used in the previous step on previously deployed network topology data or from previously deployed network topology solutions. In various embodiments, there is a different threshold value depending on whether the specified tunnel already exists in the software defined networking network. To select the appropriate threshold value, it is determined whether the specified tunnel is in the list of existing network tunnels received at 502. For network tunnels not found in the list of existing network tunnels in the software defined network, satisfying the threshold value includes having a probability value greater than the threshold value associated with creating a new network tunnel. For network tunnels found in the list of existing network tunnels in the software defined network, satisfying the threshold value includes having a probability value less than the threshold value associated with removing or deactivating an existing network tunnel. If at 506 it is determined that the one or more threshold values are satisfied, then the process proceeds to step 508. If at 506 it is determined that the one or more threshold values are not satisfied, the process returns to 502.

At 508, network tunnel(s) corresponding to the recommendation likelihood(s) satisfying the one or more threshold values are filtered based on one or more rules. If a network tunnel satisfied the threshold value associated with creating a new network tunnel in step 506 or a network tunnel satisfied the threshold value associated with removing or deactivating an existing network tunnel in step 506, the one or more rules are applied to the network tunnel. For example, one or more of the network tunnel(s) corresponding to the recommendation likelihood(s) satisfying the one or more threshold values that trigger the one or more rules are removed from being recommended for establishment or deactivation. The rules may filter suggested network tunnels based on the overall structure of the software defined networking network, the structure of the nodes connected by the recommended network tunnel, software defined networking network performance, performance metrics of the nodes connected by the recommended network tunnel, user preference, performance metrics of the recommended network tunnel, and/or cost of maintenance. For example, the one or more rules are associated software defined wide area network principles (e.g., based on whether establishing a data center to a data center network tunnel is allowed/supported by the version of the software defined network being utilized). In various embodiments, if a network tunnel satisfies one or more threshold values for deactivation, the one or more rules are checked to determine whether the network tunnel is allowed to be removed. Each network tunnel may contain an attribute indicating whether the network tunnel is editable. For example, default network tunnels that were automatically created when the software defined network was generated cannot be edited while all other network tunnels can be edited. Tunnel editability may also be designed such that the default value for some tunnels is set to true or false but can be overwritten manually by a user. If it is determined that the specified network tunnel for deactivation can be edited, then the specified network tunnel is not filtered out.

At 510, one or more of the filtered network tunnel(s) are recommended for establishment or deactivation. In some embodiments, after the network tunnel(s) are filtered based on one or more rules in 508, the remaining network tunnels after filtering are sorted based on likely resulting performance increase (e.g., based on historical performance, amount of network traffic flow of the nodes being connected, etc.), and the sorted network tunnel(s) are recommended. In some embodiments, recommended network tunnel(s) are automatically established or deactivated based on their rank position. For example, ordering of the tunnel establishment or deactivation is performed based on the rank

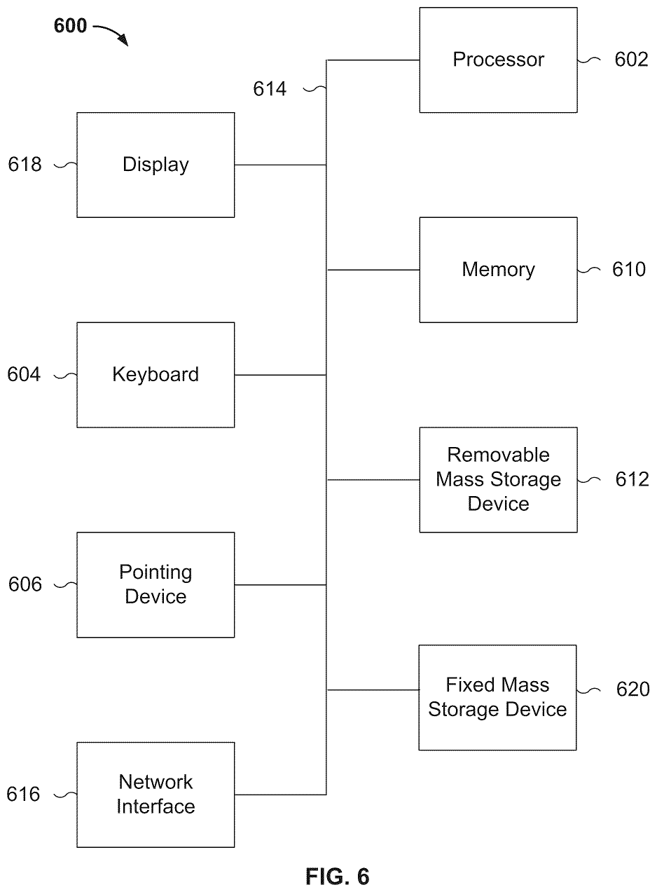

FIG. 6 is a functional diagram illustrating a programmed computer system for a method to dynamically recommend tunnels in software defined networking environments. As will be apparent, other computer system architectures and configurations can be utilized for dynamic recommendation of tunnels in software defined networking environments. Examples of computer system 600 include client 102 of FIG. 1, one or more computers used to implement software defined wide area network 104 of FIG. 1, one or more computers used to implement tunnel evaluator 112 of FIG. 1, and one or more computers used to implement one or more machine learning models used in tunnel evaluator 112 of FIG. 1. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618). In various embodiments, one or more instances of computer system 600 can be used to implement at least portions of the processes of FIGS. 4-5.

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data and objects used by the processor 602 to perform its functions (e.g., programmed instructions). For example, memory 610 can include any suitable computer-readable storage media, described below, depending on whether, for example, data access needs to be bi-directional or unidirectional. For example, processor 602 can also directly and very rapidly retrieve and store frequently needed data in a cache memory (not shown).

A removable mass storage device 612 provides additional data storage capacity for the computer system 600, and is coupled either bi-directionally (read/write) or unidirectionally (read only) to processor 602. For example, storage 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storages 612, 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving identifications of nodes of a software defined networking network;
receiving identifications of existing network tunnels connecting the nodes of the software defined networking network;
collecting metrics for the nodes and the existing network tunnels;
generating a graph representation of the nodes and the existing network tunnels with the collected metrics; and
based on the graph representation, using one or more machine learning models to identify a suggested new network tunnel between two nodes included in the nodes of the software defined networking network.

2. The method of claim 1, wherein the nodes of the software defined networking network include a branch router and a data center.

3. The method of claim 2, wherein the nodes of the software defined networking network include a branch gateway or a secure access service edge end-point.

4. The method of claim 1, wherein the software defined networking network is a software defined wide area network.

5. The method of claim 1, wherein the one or more machine learning models include a graph neural network model.

6. The method of claim 1, wherein the one or more machine learning models include a graph attention network model.

7. The method of claim 1, wherein network tunnels included in the existing network tunnels were established automatically as an initial default configuration.

8. The method of claim 1, wherein the metrics for the nodes include one or more of the following: a central processing unit utilization value, a memory utilization value, a data throughput value, or a maximum concurrent network tunnel flow value.

9. The method of claim 1, wherein the metrics for the existing network tunnels include one or more of the following: a network latency value, a jitter value, a packet loss value, a network bandwidth utilization value, or an available bandwidth metric.

10. The method of claim 1, further comprising filtering the suggested new network tunnel based on one or more rules.

11. The method of claim 1, wherein using the one or more machine learning models to identify the suggested new network tunnel includes determining embeddings for the graph representation.

12. The method of claim 11, wherein among the embeddings, an embedding for a node included in the nodes is based at least in part on one or more of the following: a degree of the node, a clustering coefficient of the node, or a betweenness centrality of the node.

13. The method of claim 1, wherein the one or more machine learning models are trained using deployed previous network topology data.

14. The method of claim 1, further comprising based on the graph representation, using the one or more machine learning models to identify a suggested network tunnel of the existing network tunnels to deactivate.

15. A system, comprising:
a processor configured to:
receive identifications of nodes of a software defined networking network;
receive identifications of existing network tunnels connecting the nodes of the software defined networking network;
collect metrics for the nodes and the existing network tunnels;
generate a graph representation of the nodes and the existing network tunnels with the collected metrics; and
based on the graph representation, use one or more machine learning models to identify a suggested new network tunnel between two nodes included in the nodes of the software defined networking network; and
a memory coupled to the processor and configured to provide the processor with instructions.

16. The system of claim 15, wherein the one or more machine learning models include a graph neural network model.

17. The system of claim 15, wherein the metrics for the nodes include one or more of the following: a central processing unit utilization value, a memory utilization value, a data throughput value, or a maximum concurrent network tunnel flow value; and wherein the metrics for the existing network tunnels include one or more of the following: a network latency value, a jitter value, or a packet loss value.

18. The system of claim 15, wherein using the one or more machine learning models to identify the suggested new network tunnel includes determining embeddings for the graph representation.

19. The system of claim 15, wherein the processor is further configured, to based on the graph representation, use the one or more machine learning models to identify a suggested network tunnel of the existing network tunnels to deactivate.

20. A computer program product embodied in a non-transitory computer readable medium and comprising computer instructions for:
receiving identifications of nodes of a software defined networking network;
receiving identifications of existing network tunnels connecting the nodes of the software defined networking network;
collecting metrics for the nodes and the existing network tunnels;
generating a graph representation of the nodes and the existing network tunnels with the collected metrics; and
based on the graph representation, using one or more machine learning models to identify a suggested new network tunnel between two nodes included in the nodes of the software defined networking network.
